(19) United States
(12) Patent Application Publication
(10) Pub. No.: US 2015/0291246 A1
(43) Pub. Date: Oct. 15, 2015

(54) FORK COMPONENT FOR AN AT LEAST PARTIALLY MUSCLE-POWERED BICYCLE

(71) Applicant: DT SWISS AG, Biel (CH)

(72) Inventors: Martin Achenbach, Biel/Bienne (CH); Martin Walthert, Aarberg (CH); Valentin Wendel, Biel/Bienne (CH)

(21) Appl. No.: 14/681,696

(22) Filed: Apr. 8, 2015

(30) Foreign Application Priority Data
Apr. 9, 2014 (DE) 10 2014 105 049.5

(51) Int. Cl. B62K 21/02; B62K 19/22; B62K 3/02

(52) U.S. Cl. CPC B62K 21/02; B62K 3/02; B62K 19/22

(57) ABSTRACT

A fork component is provided for an at least partially muscle-powered vehicle and in particular a bicycle having a fork column unit of a fibrous composite material. The fork column unit includes a fork column and a fork crown configured as two separate parts connected with one another by form-fit to form the fork column unit.

### BACKGROUND

The present invention relates to a fork component for an at least partially muscle-powered vehicle, and in particular a bicycle. Attempts have been made, specifically including bicycles, to further reduce the weight of the entire bicycle and its individual components so as to improve the agility and the accelerating characteristics during riding.

The prior art has disclosed forks for bicycles consisting of steel. Although these forks show reliability in operation, their weight is high. Therefore forks have been disclosed consisting of aluminum or aluminum alloys so as to save weight. These forks of aluminum comprise as a rule a pair of fork legs for the fork dropouts to receive the front wheel. The fork legs may be retained in a separate fork crown. Between the fork legs, the fork crown has a fork column attached to it that is rotatably received in the bicycle frame head tube and serves to transmit the steering motions from the handlebar to the fork and thus to the front wheel.

Using aluminum for the material for manufacturing bicycle forks already considerably reduced the weight. Steel or aluminum forks include a number of components pressure-bonded or locked together so as to reliably transmit the generated forces. To ensure transmission of the required forces, the joints must show increased wall thicknesses which do not only absorb the normal loads occurring in operation, but which also provide sufficient clamping forces at all times. The lightweight materials notwithstanding, this still leads to increased weights.

To further save weight, it has been disclosed to manufacture forks of fibrous composite material. Bicycle forks manufactured one-piece of fibrous composite materials have been disclosed which obtain particularly low weight. Moreover, the one-piece manufacturing allows optimization of tissue layers so that fibrous fabric will be used only where required for reasons of stability, which reduces the weight still further.

However, it has been found that the manual manufacturing processes employed may result in inaccurate positioning of the fiber mats or prepregs used so that ultimately a higher number of layers must be used than stability theoretically requires.

It is therefore the object of the present invention to provide a fork component for at least partially muscle-powered bicycles to obtain a low total weight combined with high stability.

### SUMMARY

A fork component according to the invention for an at least partially muscle-powered vehicle and in particular a bicycle comprises a fork column unit that consists at least partially of a fibrous composite material. The fork column unit comprises a fork column and a fork crown configured as two separate parts connected with one another by form-fit to form a fork column unit.

The fork component according to the invention shows considerable advantages. The interconnection of the fork column and the fork crown and the form-fit accommodation of the fork column on the fork crown allows the choice of a particularly lightweight construction. The fork column unit formed of two components is easier to manufacture at less cost. Moreover, the manufacturing process both for manufacturing the fork column and for manufacturing the fork crown can be configured so as to virtually exclude any shifting or movement of the tissue layers used. This allows a reduction in the number of tissue layers used when manufacturing each of the components so as to provide on the whole a particularly lightweight fork column unit and thus fork component. This fork column unit combines less weight with increased stability over conventional, one-piece manufacturing.

At the same time the form-fit connection between the fork crown and the fork column considerably reduces the pressing pressure acting between the fork column and the fork crown, since a form-fit connection is established between the two parts that had first been manufactured separately.

On the whole, a fork component can be provided that clearly shows less weight even combined with increased stability.

In a preferred specific embodiment, the fork column and the fork crown are connected with one another twist-proof on an accommodation section of the fork crown. In a simple case, the accommodation section of the fork crown may show a negative shape of an accommodation region of the fork column.

The fork crown and the fork column are in particular connected with one another through a form-fit accommodation.

Advantageous specific embodiments show the fork column having a non-round outer cross-section in an accommodation region. The accommodation region of the fork column is in particular provided to interact with the accommodation section of the fork crown. A non-round outer cross-section of the fork column may basically take any shape. What is preferred is an oval or elongated or polygonal shape optionally with rounded edges.

In preferred specific embodiments, the accommodation region of the fork column shows a polygonal outer cross-section. The outer cross-section may for example be triangular, quadrangular, pentagonal, hexagonal, or octagonal. These configurations would in particular appear obvious for fork components manufactured not from fibrous composite material but from metal. Applicant reserves the right to claim such a fork component comprising a fork column unit, the fork column unit comprising a fork column and a fork crown, and the fork column and the fork crown being configured as two separate parts connected to form the fork column unit and the fork column being accommodated by form-fit on the fork crown. This configuration provides for the fork column unit and the fork component together to consist at least substantially of a metal and in particular of a light metal.

All the configurations may provide for the fork column in the accommodation region to be designed diverging in the axial direction. “Axial direction” is understood to mean a longitudinal direction along the axial extension of the fork column.

The accommodation region of the fork column may be designed to be tapered in the axial direction so that the fork column widens conically, e.g. towards the lower end. The lower end of the fork column is the bottom end when the fork component is used normally as intended.

In advantageous specific embodiments, the accommodation region of the fork column and the accommodation section of the fork crown comprise mating threaded portions. It is for example possible for the fork column to be screw-connected with the fork crown. A coarse thread is preferably used with thread distances being preferably larger than is the wall thickness of the fork column. Such a thread may be formed by the fibrous composite material.

The threaded portions are in particular configured tapering. An outer diameter of a winding is preferably smaller than an inner diameter of another winding. An outer diameter of a winding is in particular smaller than an inner diameter of the next-but-one winding.

In preferred configurations, it is thus possible to insert the accommodation section and the accommodation region into one another so as to achieve a firm seat of the fork column on the fork crown with only one or two turns or even only one half turn.

In all the cases, the fork crown preferably extends transverse to the fork column, comprising at least one and in particular two fork leg accommodations or inner tube accommodations. With two fork leg accommodations provided, the fork column is disposed in particular in the center between the two fork leg accommodations.

In advantageous specific embodiments, the fork column comprises a reinforcing section above the fork crown. The reinforcing section shows in particular increased rigidity in a longitudinal direction transverse to the extension of the fork crown. This means that preferably the fork column shows a higher rigidity in the traveling direction of a bicycle equipped with such a fork component. Since in operation, the forces building in this direction are as a rule higher than transverse to this direction, the total weight of the fork component can be optimized and reduced.

It is possible and preferred for the reinforcing section to be oval or elongated in cross-section in the traveling direction.

In preferred configurations, the fork column and/or the fork crown comprise a wall or walls of a fibrous composite material.

It is possible for the fork column and/or the fork crown to comprise at least one core of a lighter-weight material. The fork crown includes in particular one or more cores disposed in the interior of the fork crown which are covered or surrounded with layers of fibrous fabric prior to manufacturing.

It is possible for the core to consist of foamed material or the like. It is also possible for the core to consist of a gas-filled container. This allows a reduction in the weight and material only where needed.

In all the configurations the fork crown may have a bearing seat, for example with a metal ring or the like embedded in the fork crown.

Preferably, a sleeve-like appendix extends axially upwardly, radially inwardly of the bearing seat. The sleeve-like appendix increases the contact surface between the fork crown and the fork column so as to obtain a larger adhesion surface and also higher rigidity of the connection and thus of the fork column unit.

In all the cases, it is possible and preferred for the fork column and the fork crown to be firstly configured as two separate components which are then glued to one another in an adhesive accommodation to form the fork column unit. The adhesive accommodation may be provided with at least one guiding section and at least one adhesive section.

It is possible for the adhesive accommodation of the fork column and/or the fork crown to be conical in shape. The external area of the fork column and the internal area of the fork crown are in particular formed slightly conically in the adhesive accommodation. The fork column is in particular approximately conical in the region of the fork crown. A slightly conical adhesive accommodation is understood to mean an adhesive accommodation showing a slight taper angled less than 10° relative to the longitudinal axis of the fork column. A taper angle is preferably less than 5° and in particular between 1° and 4°.

Preferably, at least one projection protruding inwardly is configured at least at one inner tube accommodation. A maximum radial extension is in particular less than 1% of the diameter of the inner tube accommodation. The radial extension of the projection is preferably less than 0.5 mm and in particular more than 0.05 mm. A maximum radial extension is preferably between 0.1 and 0.2 mm where 0.15 mm is preferred.

In all the configurations, it is particularly preferred for the walls of the fork column unit and/or of the fork crown to consist at least in part of several layers of cured and resin-treated fibers, fiber bundles, or fibrous fabric mats. The threads of the fibrous material may be fixed relative to one another singly or in bundles by way of separate weft threads. The several layers or at least two of the layers of the fibrous fabric mats are preferably pinned or sewn together before being placed in the mold. In particular, at least two layers of fibrous fabric mats are connected with one another across their surfaces. It is possible for the several layers of single fibers to be pinned together in many separate spots. It is also possible to sew or glue together the fibers or entire fabric mats prior to placing the fiber structures in the manufacturing mold.

It is possible and preferred to use prepregs. It is particularly preferred to employ dry fibrous fabric mats of fiber layers which are thus not prone to aging and are easy to handle. Thereafter, matrix material in the shape of resin or the like is injected into the mold or for example drawn in through a vacuum so as to completely impregnate the fibers in the mold with the resin for the matrix material.

Single fibers or fibers connected to form strings or the like are preferably used for manufacturing. A layer of very thin and lightweight material is used for a base layer. The fibers are placed thereon as desired and fixed to the base layer. The dry fibers are arranged as desired by way of suitable and in particular robot-assisted placing. The desired fiber strengths are placed locally. The fibers may be positioned and placed to meet the expected loads and stresses. Any protruding base layer portions are cut off prior to placement in the mold.

Another configuration provides for a fork component for at least partially muscle-powered vehicles and in particular bicycles to have a fork column and a fork crown. The fork column and the fork crown are configured as two separate parts which are glued together in an adhesive accommodation to form a fork column unit. The adhesive accommodation is in particular provided with a guiding section and at least one adhesive section. In the guiding section, the two components namely, the fork column and the fork crown, preferably lie entirely or substantially entirely snugly adjacent to one another. In the at least one adhesive section, there is a slight, defined gap between the fork column and the fork crown that is filled with the adhesive to obtain optimal adhesion results. It is possible and preferred to provide one adhesive section each on both sides of a guiding section. It is also possible to provide multiple guiding sections and correspondingly multiple adhesive sections.

Slight tapering of the components glued to one another facilitates assembly since the adhesive applied does not rub off the adhesive section when inserting the fork column into the fork crown.

Applicant reserves the right to claim a fork component or fork column unit for at least partially muscle-powered vehicles and in particular bicycles where the fork column unit comprises a fork column and a fork crown. The fork column and the fork crown are configured as two separate parts which are connected to form a unit or the fork column unit. The fork column is accommodated at the fork crown by form-fit.

Further advantages and features of the present invention can be taken from the description of the exemplary embodiment which will be discussed below with reference to the enclosed figures.

### BRIEF DESCRIPTION OF THE DRAWINGS

The figures show in:

FIG. 1 a schematic view of a mountain bike equipped with a fork component according to the invention;

FIG. 2 a perspective illustration of a fork component according to the invention;

FIG. 3 the fork component of FIG. 2 in section and a schematic illustration of multiple fiber or tissue layers;

FIG. 4 a perspective illustration of the fork column of the fork component of FIG. 3;

FIG. 5 a section through the fork column and the fork crown;

FIG. 5a a bottom view of the fork component from FIG. 3;

FIG. 5b the cross section A-A in FIG. 5a;

FIG. 5c the enlarged detail “Y” in FIG. 5a;

FIG. 5d is a vertical cross-section of the present fork component;

FIG. 6 a schematic front view of another embodiment of the fork component according to the invention and three pertaining sections;

FIG. 7 another fork component according to the invention in section and two cross sections perpendicular thereto;

FIG. 8 a schematic cross-section of a fork component according to the invention with enlarged details.

FIG. 9 another fork component according to the invention in section;

FIG. 10 a perspective illustration of the fork column in FIG. 9; and

FIG. 11 a schematic view of a racing bicycle equipped with a fork component according to the invention;

### DETAILED DESCRIPTION

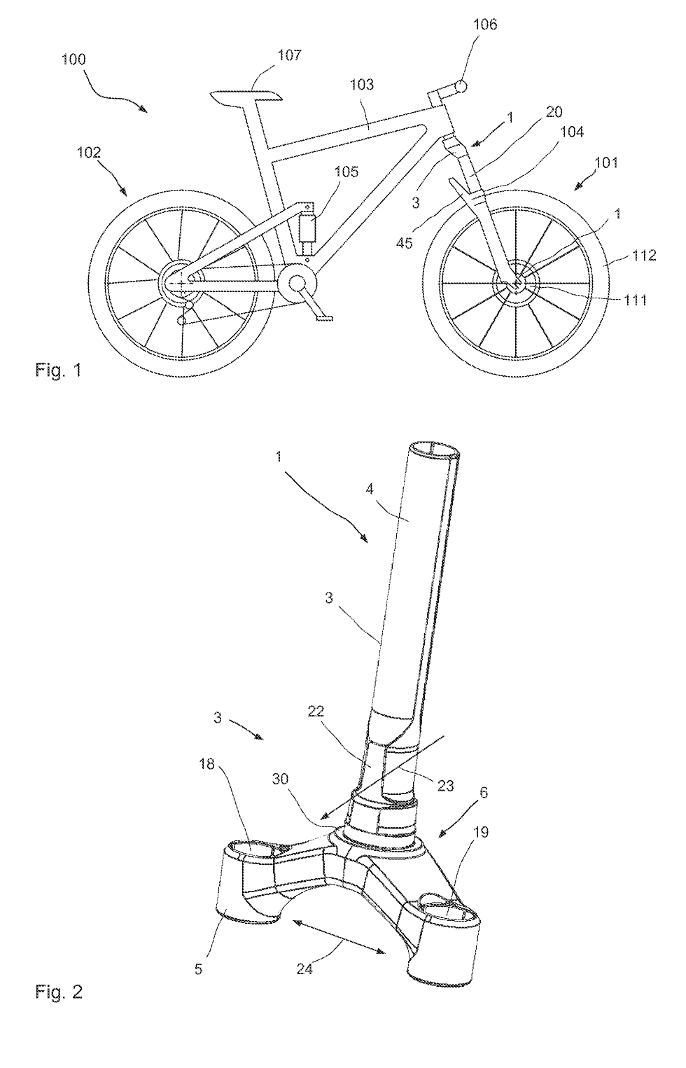

With reference to the enclosed FIGS. 1 to 11, exemplary embodiments of the invention will be discussed below. FIG. 1 illustrates a schematic representation of a mountain bike as the bicycle 100. The bicycle 100 is equipped with a front wheel 101 and a rear wheel 102. The bicycle 100 comprises a frame 103, a fork 104, a handlebar 106, and a saddle 107. Both the front wheel 101 and the rear wheel 102 are provided with a plurality of spokes 109. The rim 110 is connected with the central hub through the spokes 109. The front wheel 101 is presently provided with radial spoking while the rear wheel 102 is provided with spokes disposed at least in part tangentially at the hub to allow the transmission of rotational force. The front wheel is retained sprung at a fork 104 that is configured as a suspension fork while a damper 105 is provided for damping the rear wheel. A disk brake 111 serves for braking.

The suspension fork 104 comprises a fork column unit 3 as the fork component 1. The fork component 1 has inner tubes 20, 21 affixed to it. The inner tubes interact movably with outer tubes of an outer tube unit 45 which dampen movements of the suspension fork.

FIG. 2 shows a perspective, schematic representation of the fork component 1 according to the invention. The fork component 1 is provided with inner tubes 20 and 21 affixed to it and interacting with movable outer tubes so as to form a complete suspension fork 104 which can be employed for example in the bicycle according to FIG. 1.

It can be recognized that the reinforcing section 22 is dimensioned larger in the longitudinal direction 23 than in the transverse direction 24 for increasing the rigidity where it is required.

The fork column unit 3 consists substantially and virtually entirely of at least one fibrous composite material 2. It is possible to have very few metallic parts or the like for example worked into the bearing seat 30 or else attached thereto at a later time. Otherwise the fork component 1 consists of fibrous composite material or fibrous composite materials.

The fork column unit 3 consists of two parts 4 and 5 which are first manufactured separately. The part 4 is configured as a fork column 4 and the part 5 is designed as a kind of fork crown 5 to accommodate the fork column 4 non-rotatably and also fixed in the axial direction 11.

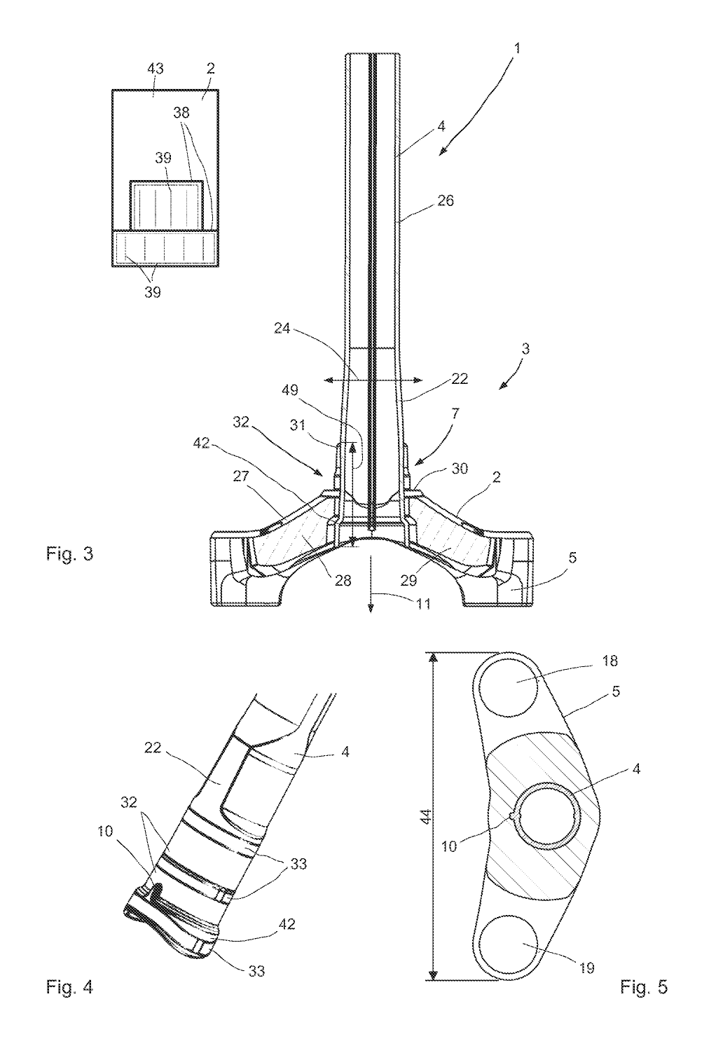

FIG. 3 shows a cross section of the fork component 1 of FIG. 2 comprising, or consisting of, a fork column unit 3.

The fork column 4 is fastened on the fork crown 5 with form-fit so as to obtain not only a force-fit connection but a form-fit connection as well. Furthermore the fork column 4 and the fork crown 5 are glue-bonded with one another by the adhesive accommodation 32. The adhesive accommodation 32 of the fork column 4 is provided with an accommodation section 6 interacting with the accommodation region 7 of the fork crown.

In order to increase the adhesive effect and the rigidity of the fork column unit 3 the fork crown 5 is also provided with a sleeve-like appendix 31 that extends from the bearing seat 30 upwardly. This means that in normal use as intended the sleeve-like appendix 31 extends from the bearing seat upwardly in the direction of the handlebar. The sleeve-like appendix 31 considerably increases the contact and mating surface between the fork column 4 and the fork crown 5.

The central region between 6 and 7 is provided with a shoulder 42 in particular to axially secure the fork column 4 in the crown to allow a firm seat even in the case of permanently changing loads.

The fact that the fork column unit 3 consists of two parts 4 and 5 which are first manufactured separately, allows easier manufacture and increased reproducibility of each part namely, the fork column 4 and the fork crown 5. This allows to position the fibrous fabric mats or fiber layers 38 of the fibrous composite material 2 for ideal strength of the respective component. The very simple geometry of the fork column 4 also provides ease of positioning the fiber layers and reproducibility with high precision.

If a one-piece fork column unit is produced in one single manufacturing step then all the walls 26 of the fork column 4 and all the walls 27 of the fork crown 5 would have to be positioned and cured in one single manufacturing step. Since the curing of fibrous composite materials tends to involve the application of pressure on the fibrous fabric layers to achieve the desired curing result, simple shapes are considerably more advantageous in manufacturing than are complicated geometries where single layers or fibers may be displaced in curing so as to show less than ideal reproducibility or involving extremely exacting work.

It has been found that inflatable hoses produce e.g. an internal pressure which due to the flexible walls or the overall flexibility of the hose may cause displacement of the fiber layers in curing and thus cause random changes to the static properties. To still ensure sufficient rigidity and strength of the component, the number of the fibrous fabric layers in the transition portions has thus far been increased in one-piece manufacturing in practice. This allowed to ensure the desired strength even given some random fiber displacement in curing.

The present invention shows the advantage over the aforementioned method that two relatively simple components are prefabricated which allow for easy and true-to-size manufacturing. After joining and gluing the two parts 4 and 5, a fork column unit 3 is provided which can be manufactured reproducibly and which reliably withstands high and extreme loads due to the form-fit connection of the fork column 4 with the fork crown 5. Bicycle front wheel forks are safety-relevant parts since if they break, there is a high risk of accidents involving possibly severe consequences which is why particular care should be taken to ensure high manufacturing constancy.

The present invention allows reproducible and cost effective manufacturing of fork components 1 whose total weight can additionally be reduced since the fork column 4 and the fork crown 5 are only made with the quantity of fiber layers 38 required for strength.

This allows to manufacture stable but still lightweight fork column units 3 for suspension forks 104. These fork column units 3 tend to include fork crowns 5 having a very large width 44. The width 44 must be adequate for the wide (profile) tires 112 used for mountain bikes (see FIG. 1) to fit between the fork legs. Also a sufficient safety margin must remain for any mud etc. clogging between the tire and the inner tubes to prevent the tire from rubbing against the fork or even preventing the front wheel from locking. Therefore the transverse region of the fork crown 5 shows large dimensions specifically in suspension forks. The width 44 is preferably at least four times and in particular at least five times the diameter of the fork leg accommodations 18 and 19. The large width is a considerable obstacle to one-piece manufacturing because the fibers have two approximately 90° bends. This considerably increases the problem of shifting fibers or fiber layers in the mold.

The fork column unit 3 may show in a region at center height a reinforcing section 22 having a bending stiffness that is higher in the longitudinal direction 23 than in the transverse direction 24. The longitudinal direction 23 corresponds to the bicycle traveling direction in normal, straight-line travel. The reinforcing section 22 thus shows a higher rigidity in the longitudinal direction 23 than in the transverse direction 24 provided transverse thereto so that the bending stiffness increases in the reinforcing section 22 about an axis parallel to the axis 24.

The fork column 4 is centrally accommodated on the fork crown 5 in the accommodation section 6. The fork crown extends substantially horizontally and transverse to the fork column 4 in the transverse direction 24. The fork crown 5 is provided with at least one fork leg accommodation to accommodate a fork leg. Or else, one or two fork legs may be manufactured integrally with the fork crown. Preferably a pair of separate fork legs 20 and 21 (see FIG. 3) is provided in fork leg accommodations 18 and 19.

For saving material and thereby weight, the fork crown 5 is provided with hollow spaces filled with cores 28. A core 28 may in particular consist of a foamed material 29. It is also possible to use gas-filled containers for the core 28. Such a container may for example show a wall of a hose material.

FIG. 3 additionally illustrates a schematic illustration of a fibrous composite material 2 consisting of multiple layers 38 of fibrous fabric. Prior to being placed in the mold, the single fiber layers 38 are pinned together or fixed relative to one another by seams 39. This is to ensure that fiber layers 38 do not shift relative to one another in the mold. This allows to considerably increase reproducibility so that optimal placement of each of the fiber layers can reduce the total weight still further.

FIG. 4 shows a perspective representation of the lower end of the fork column 4. The lower region at about center height of the fork crown is provided with a shoulder 42 which reliably prevents pulling out of the fork crown 5. The non-round cross section 8 results from the lug 10. The lug 10 extends radially outwardly and causes a form-fit connection with the fork crown 5 so as to obtain a non-rotatable connection of the fork column 4 with the correspondingly designed fork crown 5.

One can furthermore recognize the adhesive sections 32 and the guiding sections 33. The non-round cross section at the reinforcing section 22 can also be seen.

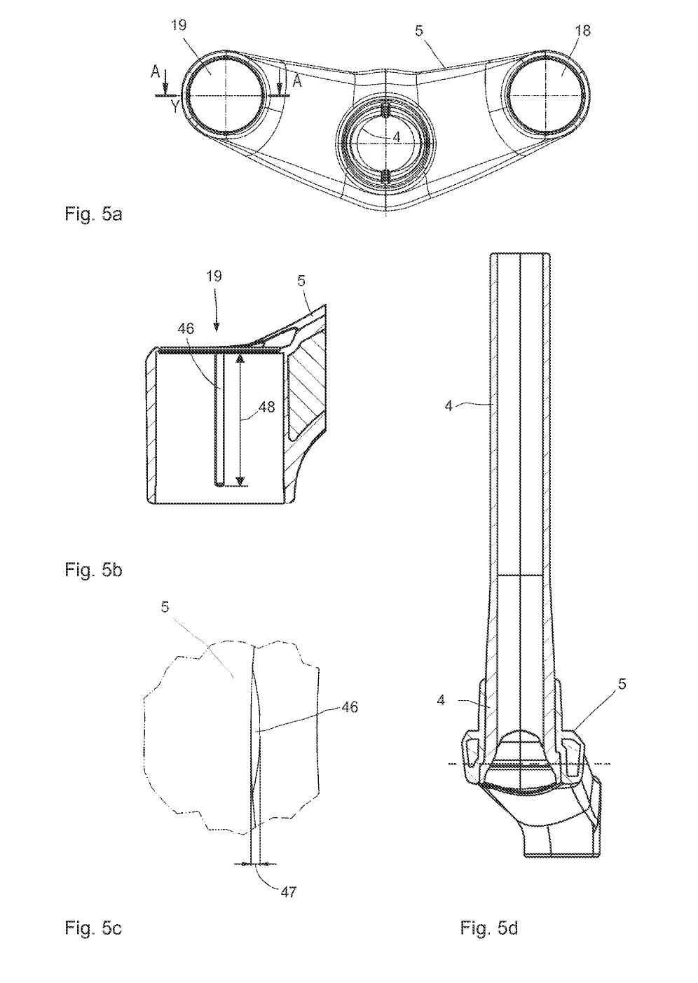

FIG. 5 shows a schematic cross-section of the fork component 1. One can clearly recognize the lug 10 that radially protrudes from the fork column 4, providing security against twisting.

FIG. 5a illustrates a bottom view of the fork component 1 substantially showing the fork crown 5 with the inner tube accommodations 18 and 19. The fork column 4 is fixedly connected in the center. One can recognize the various stepped diameters of the fork column widening downwardly.

FIG. 5b shows the cross-section A-A in FIG. 5a through the inner tube accommodation 19 which is configured in analogy to the inner tube accommodation 18. The interior of the inner tube accommodations preferably shows four projections 46 extending symmetrically disposed on the circumference, each over a peripheral width of about 1 mm to 3 mm, preferably about 2 mm+/−10%. The projections 46 are preferably aligned about parallel to the axial direction 11, extending over a length 48 that is preferably over half and in particular over ⅔ of the axial length of an inner tube accommodation 18, 19. This axial length is approximately 38 mm and thus about 5 to 7 mm less than an axial length of an inner tube accommodation 18, 19.

FIG. 5c illustrates the detail “Y” from FIG. 5a showing a top view of the projection 46. The projection 46 is configured rounded in a horizontal cross-section, showing a radially inwardly extension 47 between approximately 0.1 mm and 0.2 mm and in particular 0.15 mm.

When gluing the inner tubes with the fork crown 5 the projections 46 serve to provide a defined gluing gap so as to obtain an optimal adhesion effect.

FIG. 5d shows a cross-section of the fork component 1 with the fork column 4 that widens downwardly. In the longitudinal direction 23 the wall thickness of the fork column likewise increases downwardly. In the bottommost region of the fork crown 5 the wall thickness of the fork column 4 in the longitudinal direction 23 may be twice that at the top or free end of the fork column 4. The wall thickness may show still greater differences in the longitudinal direction 23. This obtains increased rigidity in the dimension desired.

In the transverse direction 24 the wall thickness of the fork column 4 varies less or not at all.

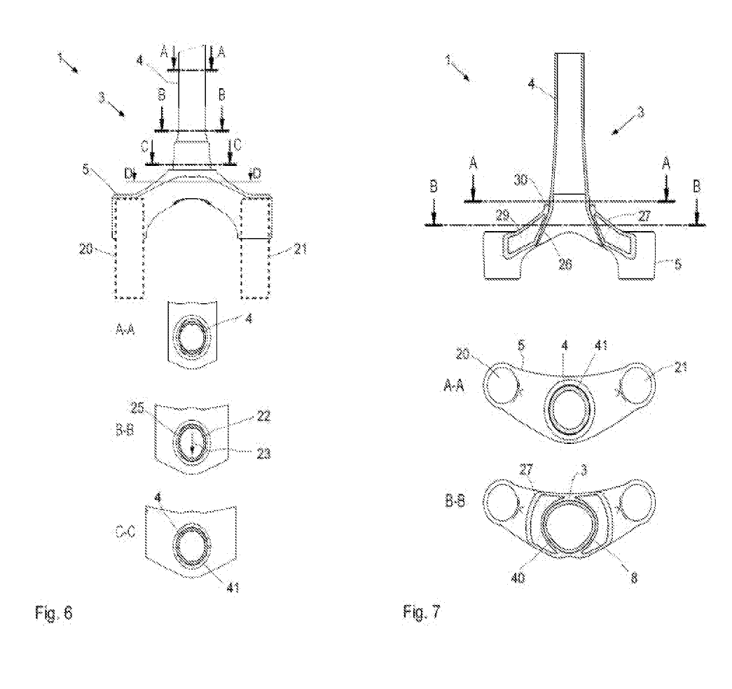

FIG. 6 shows another exemplary embodiment of a fork component 1 according to the invention comprising a fork column unit 3 with a fork column 4 and a fork crown 5. Additionally, inner tubes 20 and 21 are inserted in dashed lines, fixed to fork leg accommodations or inner tube accommodations 18 and 19.

Section A-A shows a cross section of the fork column 4 that is substantially round in this place.

Cross-section B-B at the level of the reinforcing section 22 shows a slightly oval cross section of the fork column 4 which is larger in the longitudinal direction 23.

Cross-section C-C shows the outer cross-section of the unit 1 that is once again substantially round in the region of the lower bearing seat.

The form-fit connection ensures that the fork column 4 cannot rotate relative to the fork crown 5 in operation so as to considerably reduce the risk of accidents. The separate manufacturing of the fork column 4 and the fork crown 5 and subsequent connection of the two parts to form the fork column unit 3 allows to ideally match each of the wall thicknesses 26 and 27 so as to obtain high stability combined with low weight overall.

Section D-D is basically already shown in FIG. 5. The non-round contour of the fork column 4 with the lug 10 protruding outwardly and the mating recess in the fork crown 5 ensures a non-rotatable connection of the fork column unit 3.

FIG. 7 shows another exemplary embodiment of a fork component 1 according to the invention configured as a fork column unit 3. This fork column 4 is configured diverging downwardly in the accommodation section 6. This enables a larger connection and adhesive surface between the fork column 4 and the fork crown 5.

Furthermore the cross-section 8 of the fork column 4 is non-round in the accommodation section 6 wherein in the region of the non-round cross-section 8 the fork column 4 shows a larger extension in the transverse direction 24 than in the longitudinal direction 23.

As above, the fork crown 5 may show hollow spaces each filled with one core or with multiple cores 28 e.g. of a foamed material 29. The cores 28 may be removed after finishing. Or else it is possible for the cores of e.g. foamed material 29 to permanently remain in the fork column unit 3. The fork column unit 3 or the fork column 4 may be round in cross-section 41 in the region of the bearing seat 30. In the region of the accommodation section 6 or the accommodation region 7 the cross-sections of the fork column 4 and the fork crown 5, which are designed non-round as the cross-section B-B reveals, are matched to one another.

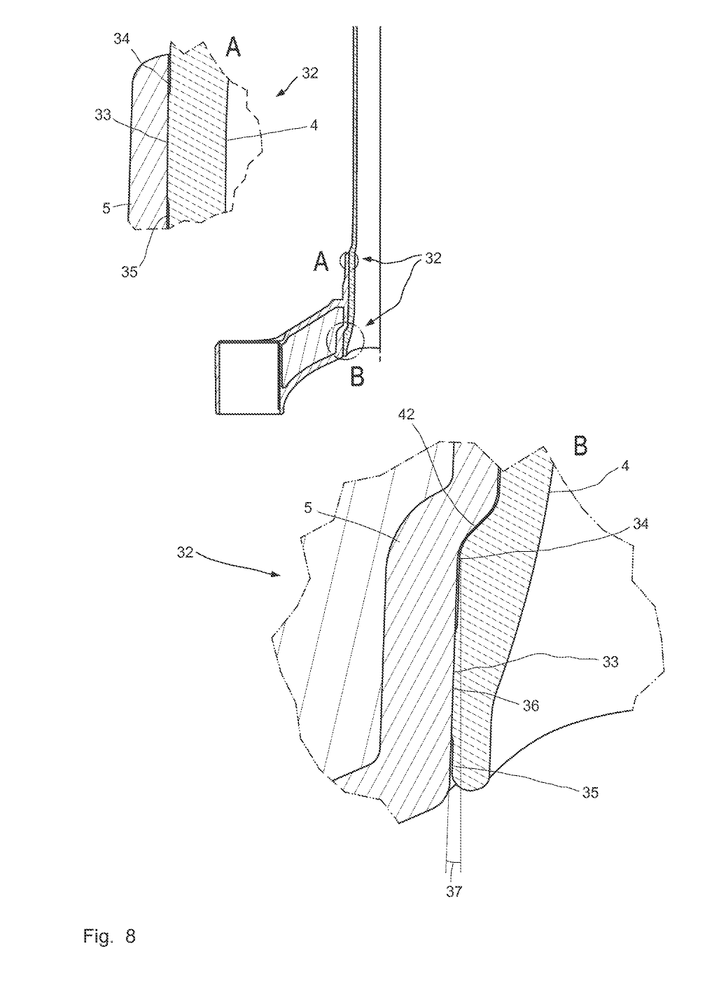

FIG. 8 shows conceivable details of the preceding exemplary embodiments of the fork component 1, comprising a fork column unit 3 having a fork column 4 and a fork crown 5. The details A and B in FIG. 8 in particular also show the enlarged configurations of the accommodation section 6 or the accommodation region 7 of the fork component in FIG. 3 or else in FIG. 6 or FIG. 7.

The enlarged detail A shows that the upper region of the accommodation section 6 or the accommodation region 7 is provided with a first adhesive accommodation 32 comprising a guiding section 33 and two adhesive sections 34 and 35 extending both above and beneath the guiding section 33. The components 4, 5 are preferably in direct contact with one another in the guiding section 33. The regions of the adhesive sections 34 and 35 are provided with a narrow, defined gap filled with adhesive which provides for particularly reliable adhesion to the adhesive accommodation 32. The gap width is in particular narrower than a wall thickness of the fork column 4, preferably being between 10 μm and 500 μm, and in particular less than 250 μm.

In analogy to the upper adhesive accommodation 32 a lower adhesive accommodation 32 is provided which is shown enlarged in the detail “B”. The lower adhesive accommodation 32 includes a guiding section 33 and adjacent thereto, adhesive sections 34 and 35. The adhesive sections 34 and 35 in turn have a defined gap filled with adhesive and providing reliable adhesion of the two components.

To ensure that the fork column 4 can be introduced into the fork crown 5 so that no adhesive rubs off the adhesive sections 34, 35, the adhesive accommodations 32 are preferably designed slightly conically. An angle 37 between a central axis of the fork column 4 and the fork crown 5 and the contact surfaces on the guiding sections 33 and the adhesive sections 34, 35 is preferably between 0° and 10° and in particular between 1° and 5°, and particularly preferably approximately 2° to 3°.

This exemplary embodiment once again provides for the region of the adhesive accommodation 32 to show at least a non-round outer cross-section 8 to ensure a form-fit connection between the fork column 4 and the fork crown 5 e.g. by way of outwardly protruding lugs.

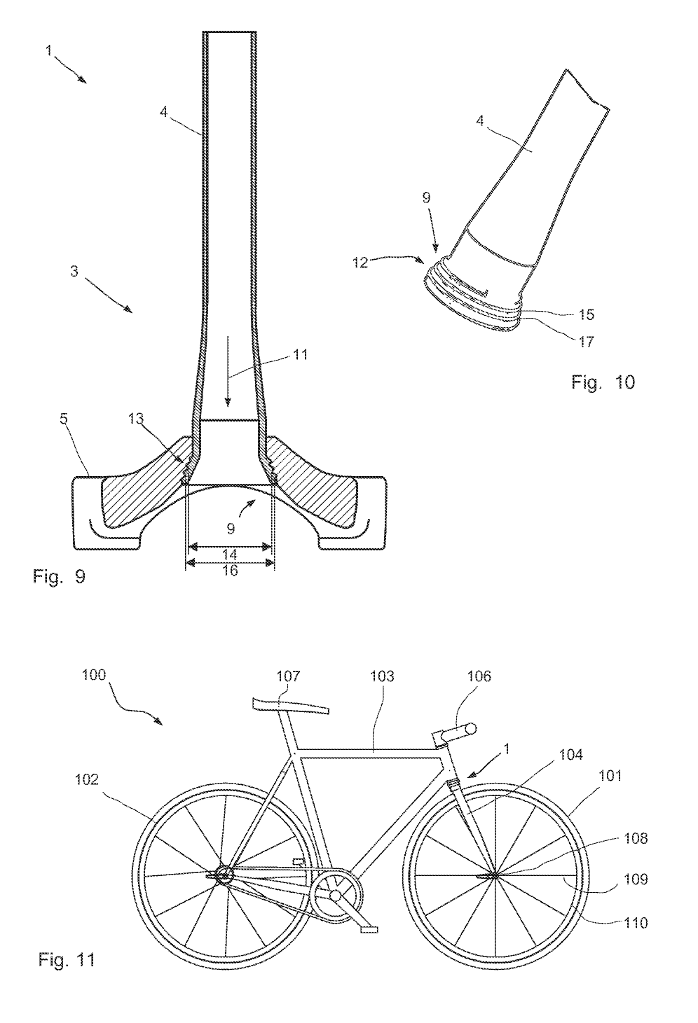

FIG. 9 shows another exemplary embodiment of a fork component 1 according to the invention which in turn is configured as a fork column unit 3. The one-piece fork column unit 3 consists of the fork column 4 and the fork crown 5, which are again of fibrous composite material g [sic]. Preferably the fibrous composite material used is the same for both of the two components 4, 5.

In all the exemplary embodiments the fibrous composite material used may be the same for the components 4, 5. Or else, different fibrous composite materials may be used. The same fibrous material with different matrix materials and/or different fibrous materials with the same matrix materials may be partially or entirely used.

The exemplary embodiment according to FIG. 9 likewise provides for the accommodation section 6 of the fork column 4 to expand conically downwardly. The components 4, 5 at the accommodation section 6 or the accommodation region 7 show mating threaded portions 12, 13 so that the fork column 4 is provided with an external thread 12 and the fork crown 5, with an internal thread 13. The threaded portions 12, 13 are disposed on a cone 9. The cone angle is such that in particular immediately adjacent thread turns show diameter differences so that one half or one turn of the fork column 4 is sufficient to ensure a firm seat of the fork column 4 on the fork crown 5 after inserting the fork column 4 into the fork crown 5. This likewise establishes a form-fit connection which may be additionally secured from inadvertently detaching by an adhesive.

It is possible for the outer diameter 14 of a thread turn 15 to be dimensioned smaller than is the inner diameter 16 of the next-but-one, axially adjacent turn 17.

Again it is possible for the fork crown to be provided with hollow spaces optionally filled with cores.

FIG. 10 shows a schematic, perspective illustration of the threaded fork column 4.

FIG. 11 represents a bicycle 100 configured as a roadster or racing bicycle equipped with a front wheel 101 and a rear wheel 102. The bicycle comprises a frame 103, a fork 104, a handlebar 106, and a saddle 107. Both the front wheel 101 and the rear wheel 102 are provided with a plurality of spokes 109. The rims 110 are connected with the central hubs by means of the spokes 109. The front wheel 101 is presently provided with radial spoking while the rear wheel 102 is provided with spokes disposed at least in part tangentially at the hub to allow the transmission of rotational force. The fork 104 comprises an inner tube unit 3 as it has been described above. This fork component 1 may also be used in a racing bicycle.

### LIST OF REFERENCE NUMERALS

| | | | |
|---|---|---|---|
| 1 | fork component | 32 | adhesive accommodation |
| 2 | fibrous composite material | 33 | guiding section |
| 3 | fork column unit | 34 | adhesive section |
| 4 | fork column | 35 | adhesive section |
| 5 | fork crown | 36 | external area |
| 6 | accommodation section of 5 | 37 | angle |
| 7 | accommodation region of 4 | 38 | layer, fibrous fabric mat |
| 8 | non-round cross section | 39 | seam |
| 9 | cone | 40 | non-round cross section |
| 10 | lug | 41 | round cross-section |
| 11 | axial direction | 42 | shoulder-like expansion |
| 12 | threaded portion at 4 | 43 | base layer |
| 13 | threaded portion at 5 | 44 | width |
| 14 | outer diameter of 15 | 45 | outer tube unit |
| 15 | thread winding | 46 | projection |
| 16 | inner diameter of 17 | 47 | extension |
| 17 | thread winding | 48 | length |
| 18 | inner tube accommodation | 49 | length |
| 19 | inner tube accommodation | 100 | bicycle |
| 20 | fork leg | 101 | front wheel |
| 21 | fork leg | 102 | rear wheel |
| 22 | reinforcing section | 103 | frame |
| 23 | longitudinal direction | 104 | fork, suspension fork |
| 24 | transverse direction | 105 | damper |
| 25 | cross-section of 22 | 106 | handlebar |
| 26 | wall | 107 | saddle |
| 27 | wall | 108 | hub |
| 28 | core | 109 | spokes |
| 29 | foamed material | 110 | rim |
| 30 | bearing seat | 111 | disk brake |
| 31 | sleeve-like appendix | 112 | tire |

1. A fork component for an at least partially muscle-powered vehicle and in particular a bicycle, comprising: a fork column unit at least part of which consists of a fibrous composite material, the fork column unit comprises a fork column and a fork crown which are configured as two separate parts connected to one another by form-fit to form a fork column unit.

2. The fork component according to claim 1 wherein the fork column and the fork crown are connected to one another non-rotatably relative to the longitudinal axis on an accommodation section of the fork crown.

3. The fork component according to claim 1 wherein the fork column shows a non-round outer cross-section in an accommodation region.

4. The fork component according to claim 3 wherein the fork column shows a polygonal outer cross-section in the accommodation region.

5. The fork component according to claim 3 wherein the fork column shows at least one lug projecting outwardly in the accommodation region.

6. The fork component according to claim 3 wherein the cross-section in the accommodation region of the fork column is mated to the cross-section in the accommodation section of the fork crown.

7. The fork component according to claim 1 wherein the fork column and the fork crown of the fork column unit are connected with one another by form-fit in an axial direction of the fork column.

8. The fork component according to claim 7 wherein the fork column is configured in the accommodation region diverging in the axial direction.

9. The fork component according to claim 1 wherein the fork column is configured in the accommodation region cone-shaped in the axial direction.

10. The fork component according to claim 1 wherein mating threaded portions are comprised in the accommodation region on the fork column and in the accommodation section on the fork crown.

11. The fork component according to claim 10 wherein the threaded portions are cone-shaped so that an outer diameter of a thread winding is smaller than an inner diameter of another thread winding.

12. The fork component according to claim 1 wherein the fork crown extends transverse to the fork column and wherein the fork crown comprises at least one fork leg accommodation.

13. The fork component according to claim 1 wherein the fork crown comprises a pair of fork leg accommodations between which the fork column is received on the fork crown.

14. The fork component according to claim 1 wherein above the fork crown the fork column comprises a reinforcing section showing higher rigidity in a longitudinal direction transverse to the extension of the fork crown.

15. The fork component according to claim 14 wherein the reinforcing section is oval or elongated in cross-section.

16. The fork component according to claim 1 wherein the fork column and/or the fork crown comprise(s) a wall of a fibrous composite material and at least one core of a more lightweight material.

17. The fork component according to claim 1 wherein the core consists of a foamed material.

18. The fork component according to claim 1 wherein the fork column is provided with a shoulder-like expansion.

19. The fork component according to claim 1 wherein the fork crown is provided with a bearing seat.

20. The fork component according to claim 1 wherein a sleeve-like appendix extends axially upwardly, radially inwardly of the bearing seat.

21. The fork component according to claim 1 wherein the fork column and the fork crown are configured as two separate parts which are glued to one another in an adhesive accommodation to form the fork column unit wherein the adhesive accommodation is provided with a guiding section and at least one adhesive section.

22. The fork component according to claim 1 wherein the fork column and/or the fork crown are configured cone-shaped in the adhesive accommodation.

23. The fork component according to claim 1 wherein at least sections of the external area of the fork column and of the internal area of the fork crown are configured slightly cone-shaped in the adhesive accommodation.

24. The fork component according to claim 1 wherein a taper angle is less than 5° and in particular between 1° and 4°.

25. The fork component according to claim 1 wherein at least one inwardly protruding projection is configured at least at one inner tube accommodation.

26. The fork component according to claim 1 wherein at least parts of the walls of the fork column unit consist of multiple layers of cured, resin-treated fiber layers which are pinned or sewn to one another.

27. The fork component according to claim 1 wherein multiple fiber layers are connected with one another across their surfaces.

28. A fork component for at least partially muscle-powered vehicles and in particular bicycles, comprising: a fork column and a fork crown, the fork column and the fork crown are configured as two separate parts glued to one another to form a fork column unit wherein the adhesive accommodation is provided with a guiding section and an adhesive section.
